(19) United States
(12) Patent Application Publication
(10) Pub. No.: US 2001/0013390 A1
(43) Pub. Date: Aug. 16, 2001

(54) Process and device for applying glue and brazing material to a metallic catalyst carrier body

(75) Inventor: Wolfgang Staubwasser, Bergisch Gladbach (DE)

Correspondence Address: WERNER H. STEMER, P.O. Box 2480, Hollywood, FL, 33022, US

(73) Assignee: Emitec Gesellschaft fur Emissionstechnologie mbH.

(21) Appl. No.: 09/839,766

(22) Filed: Apr. 20, 2001

Related U.S. Application Data
(63) Continuation of application No. 08/881,088, filed on Jun. 23, 1997, now abandoned.
Application No. 08/881,088 is a continuation of application No. 08/467,591, filed on Jun. 6, 1995, now abandoned.
Application No. 08/467,591 is a division of application No. 07/621,068, filed on Nov. 30, 1990, now abandoned.
Application No. 07/621,068 is a continuation of application No. PCT/DE89/00080, filed on Feb. 10, 1989.

(30) Foreign Application Priority Data
May 31, 1988 (DE) P 38 18 512.1

(51) Int. Cl. B31F 1/22

(52) U.S. Cl. 156/205

(57) ABSTRACT

A process for applying glue and brazing material to a honeycomb body includes coating structured metal sheets with adhesive or binder at given positions of zones of the metal sheets to be subsequently coated with brazing material and brazed. Subsequently, the metal sheets are layered or wound into a honeycomb body having a multiplicity of channels for the passage of a fluid. A continuously adhering brazing powder is applied to all of the given positions of the layered or wound body. Excess brazing powder is shaken or blown out of the body. A corresponding device includes a transport path for structured sheets and rotatable sponge-like rollers to be saturated with adhesive or binder. The rollers are disposed laterally alongside and/or above and/or below the transport path. The rollers are rotatable by a transport motion of the sheets or drive mechanisms are provided for rotating the rollers.

### CROSS REFERENCE TO RELATED APPLICATIONS

This is a continuation of application Ser. No. 08/881,088, filed Jun. 23, 1997, which was a continuation of application Ser. No. 08/467,591, which was a divisional of application Ser. No. 07/621,068, filed Nov. 30, 1990, which was a continuation of International Application PCT/DE89/00080, filed Feb. 10, 1989.

### BACKGROUND OF THE INVENTION

### Field of the Invention

The invention relates to a process and device for applying glue or adhesive and brazing material to a metal honeycomb body being wound or layered from layers of structured metal sheets and having a multiplicity of channels for the passage a fluid.

Many forms of honeycomb bodies made of layers of structured metal sheets being wound or layered together, are known. They are particularly needed for catalytic converters that are installed near the engine in motor vehicles. German Published, Non-Prosecuted Application DE 29 24 592 A1, which is the point at which the present invention begins, describes such bodies and processes for applying glue and brazing material. Other forms of catalyst carrier bodies for which the present invention is suitable are found, for instance, in Published European Applications 0 136 515 A2; 0 159 468 A2; 0 220 468 A1, corresponding to U.S. Pat. No. 4,818,746; 0 245 737 A1, corresponding to U.S. Pat. Nos. 4,923,109 and 4,847,962; and 0 245 738 A1, corresponding to U.S. Pat. Nos. 4,946,822 and 4,803,189.

The prior art includes at least three processes for applying brazing material to honeycomb bodies, namely applying glue and brazing material prior to winding as described in German Published, Non-Prosecuted Application DE 29 24 592 A1, applying glue and brazing material to the end surface or end face after winding, which is also described in that patent application, and applying dry brazing material without the use of adhesives and binders, in accordance with Published European Application 0 136 514 A1. When applying brazing material prior to winding or layering, there are grains of brazing material between the various sheet-metal layers. Melting of the brazing material grains may undesirably increase the spacing between the metal sheets and cause them to shift relative to one another. If the glue and brazing material are applied to the end surface, either there is an undesirably large amount of brazing material in the gaps next to the points of contact, or if bonding emulsion is used, an additional period of time is needed for drying of the adhesive before powdered brazing material is applied. Moreover, applying brazing material to the end surface later does not enable selective brazing of individual strips in the interior of the honeycomb body. Dry application of brazing material requires relatively complicated equipment and a certain brazing material composition with respect to the grains of brazing material.

### SUMMARY OF THE INVENTION

It is accordingly an object of the invention to provide a process and device for applying glue and brazing material to a metallic catalyst carrier body, which overcome the hereinafore-mentioned disadvantages of the heretofore-known methods and devices of this general type and which enable fast production, with the later brazed connections being of high quality.

With the foregoing and other objects in view there is provided, in accordance with the invention, a process for applying glue and brazing material to a honeycomb body, which comprises coating structured metal sheets with a material selected from the group consisting of adhesive and binder at given positions of zones of the metal sheets to be subsequently coated with brazing material and brazed; subsequently layering or winding the metal sheets into a honeycomb body having a multiplicity of channels for the passage of a fluid; ,applying continuously adhering brazing powder to all of the given positions of the layered or wound body; and removing any excess brazing powder from the body, such as by shaking or blowing it out of the body.

The procedure according to the invention is especially time-saving, among other advantages. While the structured metal sheets are being transported to a winding or layering machine, they may be provided with adhesive or binder in the regions desired. Through the use of capillary action during the winding or layering, the adhesive or binder sets precisely in the gaps beside the connecting points, so that grains of brazing material can adhere precisely where they are needed. It becomes possible for the first time to apply brazing material selectively to strips in the interior of the honeycomb body, without grains of brazing material undesirably sticking between the contacting surfaces. Applying brazing material to strips only on the end surface, on either one or both end surfaces, is also made simpler.

In accordance with another mode of the invention, there is provided a process which comprises selecting a bonding emulsion as the adhesive.

In accordance with a further mode of the invention, there is provided a process which comprises performing the layering or winding step before the bonding emulsion has completely dried.

The process is particularly advantageous when bonding emulsion is used. Published European Application 0 049 489 A1 specifically describes the advantages of the use of bonding emulsion in terms of the dosage of the quantity of brazing material. In the process according to the invention, the drying time for the bonding emulsion coincides with the time for winding or layering of the honeycomb body, which simplifies the procedure. Moreover, despite the advantages of the use of bonding emulsion, they need not be attained at the cost of the disadvantages that the presence of grains of brazing material between the connecting points of the metal sheets may have in the known process.

While maintaining the advantages of end-surface or end-face application of brazing material after winding or layering, the process according to the invention nevertheless also makes it possible to selectively apply brazing material only to the points of contact, rather than to all of the surfaces near the end surfaces.

This can be accomplished by applying glue in strips to the corrugated sheets only on the crests of the corrugations, or in small zones. This saves brazing material and lowers the risk of subsequent erosion during operation, which alloying of the base material to the brazing material could cause.

In accordance with an added mode of the invention, there is provided a process which comprises coating the structured metal sheets with the material selected from the group consisting of adhesive and binder in at least one strip extending perpendicularly, parallel or at an angle to the structure of the sheets.

In accordance with an additional mode of the invention, there is provided a process which comprises coating the structured metal sheets with the material selected from the group consisting of adhesive and binder at least in a narrow zone on at least one edge of the metal sheets for creating brazed connections at least at one end surface or end face of the honeycomb body.

In accordance with an yet another mode of the invention, there is provided a process which comprises coating the structured metal sheets with the material selected from the group consisting of adhesive and binder in strips of the metal sheets for creating brazed connections being disposed in the interior and spaced apart from the end surfaces or end faces of the honeycomb body.

In accordance with an yet a further mode of the invention, there is provided a process which comprises carrying out the step of layering the metal sheets with alternating layers of smooth and corrugated sheets, and carrying out the coating step by applying the material selected from the group consisting of adhesive and binder to at least one of the smooth and corrugated sheets.

In accordance with an yet an added mode of the invention, there is provided a process which comprises carrying out the step of layering the metal sheets with alternating layers of smooth sheets and corrugated sheets having corrugations with crests, and carrying out the coating step by applying the material selected from the group consisting of adhesive and binder only to the crests of the corrugations in the zones to be brazed.

With the objects of the invention in view, there is also provided a device for applying adhesive or binder to sheets of a honeycomb body, comprising a transport path for structured sheets having zones to be coated, and rotatable sponge-like rollers to be saturated with a material selected from the group consisting of adhesive and binder, the rollers being disposed laterally alongside and/or below and/or above the transport path for touching at least some of the zones of the structured sheets, the rollers being rotatable by a transport motion of the sheets or drive mechanisms are provided for rotating the rollers.

These rollers can touch the structured sheets in the desired zones and as a result apply glue to them in strips and/or on the crests of the corrugations. Sponge-like rollers of this kind may be mounted in such a way that they are free-wheeling, and accordingly the sheet traveling past them during glue application sets them into rotation. This assures a uniform delivery of adhesive or binder, and because of a certain unavoidable slip between the rollers and the sheets, uniform layer thicknesses of adhesive or binder are attained.

Other features which are considered as characteristic for the invention are set forth in the appended claims.

Although the invention is illustrated and described herein as embodied in a process and device for applying glue and brazing material to a metallic catalyst carrier body, it is nevertheless not intended to be limited to the details shown, since various modifications and structural changes may be made therein without departing from the spirit of the invention and within the scope and range of equivalents of the claims.

The construction and process of operation of the invention, however, together with additional objects and advantages thereof will be best understood from the following description of specific embodiments when read in connection with the accompanying drawing.

### BRIEF DESCRIPTION OF THE DRAWINGS

FIG. 1 is a diagrammatic, perspective view of a spirally wound catalyst carrier body during a winding process; and

FIG. 2 is a fragmentary, longitudinal sectional view of a device for applying adhesive or binder.

### DESCRIPTION OF THE PREFERRED EMBODIMENTS

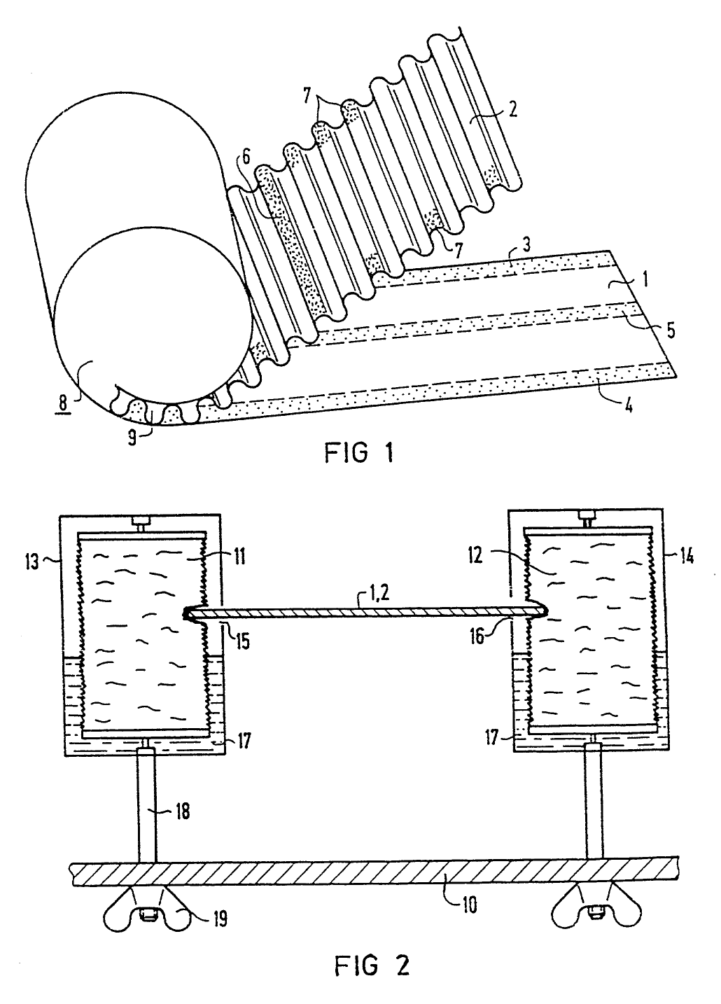

Referring now to the figures of the drawing in detail and first, particularly, to FIG. 1 thereof, there is seen a spirally wound catalyst carrier body 8 including smooth metal sheets 1 and corrugated or wavy metal sheets 2, shortly before the end of the winding process. A honeycomb body of this type has a plurality of channels 9 for passage of a fluid. Various options for applying glue prior to the winding are illustrated by detailed views of the sheets 1, 2 that have not yet been completely wound into place. Glue may, for instance, be applied to the smooth sheet 1 in edge zones 3, 4. Glue may also be applied to strips 5 in the interior of the honeycomb body 8 to be wound. Applying glue to the corrugated sheet 2 may also be advantageous, and once again there are many options. Preferably, the adhesive or binder is applied to only the crests of the corrugations. This may be performed over the entire width of the sheet, as shown at a zone 6 to which glue has been applied. Another option is to apply brazing material to all of the crests, or to some crests at intervals, in an edge zone of the metal sheet, as indicated by zones 7. Combinations of these options may also be advantageous. The process illustrated herein in terms of a spirally wound catalyst carrier body is also suitable for layered honeycomb bodies, or those made of stacks of sheet metal wrapped in opposite directions, of the kind known from the prior art.

FIG. 2 diagrammatically shows a device for applying adhesive or binder. In the present exemplary embodiment the device is specifically used for applying glue laterally to the top and bottom of smooth or corrugated strips of sheet metal. Two sponge-like rollers 11, 12 are mounted on a retaining plate 10 and spaced apart by such a distance that a smooth sheet 1 or a corrugated sheet 2 passed between the two rollers presses into the sponge-like rollers 11, 12 to a distance of several millimeters on both sides. The rollers 11, 12 are disposed in housings 13, 14, which have openings 15, 16 for the passage of the sheets 1, 2. A supply 17 of adhesive or binder may, for instance, be present inside the housings 13, 14. The housings 13, 14 are mounted on holders 18, which in turn are secured in oblong slots of the structured plate 10, for example with thumb screws 19. This makes it simple to adjust to various widths of the sheets 1, 2. The rollers 11, 12 are rotatably supported. Either they themselves may be driven, or they may be rotated by the sheets passed between them.

Depending on the capabilities of the rollers 11, 12, this device makes it possible to apply glue in strips to the edges of smooth sheets or to the edges of the crests of corrugated sheets.

The present invention is particularly well suited to the production of metal catalyst carrier bodies that are intended to be installed near the engine and are exposed to severe thermal strains.

I claim:

1. A process for forming a metallic catalyst carrier body having a multiplicity of at least partly structured sheet-metal layers contacting one another at connecting positions and defining a multiplicity of channels for the passage of a fluid, the process which comprises:
a) providing at least one metal sheet with corrugations having crests;
b) defining first zones on the metal sheet to be continuous along some entire crests and defining second zones on at least one narrow edge zone of the metal sheet;
c) applying adhesive material only to the crests within the zones and leaving all other locations of the metal sheet substantially free of adhesive material;
d) subsequently incorporating the metal sheet in a honeycomb body, the adhesive material being naturally displaced to further positions adjacent the connecting positions;
e) applying brazing powder to adhere to the adhesive material at the further positions of the honeycomb body; and
f) removing any excess brazing powder from the body and brazing the honeycomb body for forming a metallic catalyst carrier body.

2. A process for forming a metallic catalyst carrier body, which comprises:
providing at least one metal sheet with corrugations having crests;
defining first zones on the metal sheet to be continuous along some entire crests and defining second zones on only a narrow edge zone of the metal sheet;
applying adhesive material only to the crests within the zones and leaving all other locations of the metal sheet substantially free of adhesive material;
subsequently forming the metal sheet into a honeycomb body with a multiplicity of sheet-metal layers contacting each other at a plurality of connecting positions and defining a multiplicity of channels for the passage of a fluid, the adhesive material being naturally displaced to further positions adjacent the connecting positions;
applying brazing powder to adhere to the adhesive material at the further positions of the honeycomb body; and
removing any excess brazing powder from the honeycomb body and brazing the honeycomb body by melting the brazing powder for forming a metallic catalyst carrier body configured to carry catalytically active material.
